(19) United States
(12) Patent Application Publication
(10) Pub. No.: US 2022/0329328 A1
(43) Pub. Date: Oct. 13, 2022

(54) TELECOMMUNICATION NETWORK MACHINE LEARNING DATA SOURCE FAULT DETECTION AND MITIGATION

(71) Applicant: AT&T Intellectual Property I, L.P., Atlanta, GA (US)

(72) Inventors: Prince Paulraj, Coppell, TX (US); Ana Armenta, San Jose, CA (US); Lauren Savage, Santa Clara, CA (US)

(21) Appl. No.: 17/225,784

(22) Filed: Apr. 8, 2021

(51) Int. Cl. H04B 17/17; H04L 12/26; H04B 17/11; H04B 17/21; H04B 17/23; G06N 20/00

(52) U.S. Cl. CPC H04B 17/17; H04L 43/067; H04B 17/11; H04B 17/21; H04B 17/23; G06N 20/00

(57) ABSTRACT

A processing system may determine a plurality of input features of a first machine learning model that is deployed in a telecommunication network for a prediction task associated with an operation of the telecommunication network and apply a time series forecast model to a historical data set of a first data source associated with at least one of the plurality of input features to generate a forecast upper bound of a first characteristic of the first data source for a first time period and a forecast lower bound of the first characteristic of the first data source for the first time period. The processing system may then detect that the first characteristic exceeds one of the forecast upper bound or the forecast lower bound during the first time period and generate an alert that an output of the first machine learning model may be faulty, in response to the detecting.

The present disclosure relates generally to telecommunication network operations, and more particularly to methods, computer-readable media, and apparatuses for generating an alert in response to detecting that a first characteristic of data of a first data source associated with an input feature of a first machine learning model exceeds a forecast upper bound or a forecast lower bound of the first characteristic for a first time period.

### BACKGROUND

Machine learning in computer science is the scientific study and process of creating algorithms based on data that perform a task without any instructions. These algorithms are called models and different types of models can be created based on the type of data that the model takes as input and also based on the type of task (e.g., prediction, classification, or clustering) that the model is trying to accomplish. The general approach to machine learning involves using the training data to create the model, testing the model using the cross-validation and testing data, and then deploying the model to production to be used by real-world applications. In addition, machine learning models are used for a variety of prediction tasks in telecommunication network operations, including self-optimizing network (SON) and/or software defined network (SDN) configuration, fraud detection and prevention, network performance monitoring and alerting, and so forth.

### SUMMARY

In one example, the present disclosure describes a method, computer-readable medium, and apparatus for generating an alert in response to detecting that a first characteristic of data of a first data source associated with an input feature of a first machine learning model exceeds a forecast upper bound or a forecast lower bound of the first characteristic for a first time period. For instance, in one example, a processing system including at least one processor may determine a plurality of input features of a first machine learning model that is deployed in a telecommunication network for a prediction task associated with an operation of the telecommunication network and apply a time series forecast model to a historical data set of a first data source associated with at least one of the plurality of input features to generate a forecast upper bound of a first characteristic of the first data source for a first time period and a forecast lower bound of the first characteristic of the first data source for the first time period. The processing system may then detect that the first characteristic exceeds one of the forecast upper bound or the forecast lower bound during the first time period and generate an alert that an output of the first machine learning model may be faulty, in response to the detecting.

### BRIEF DESCRIPTION OF THE DRAWINGS

The present disclosure can be readily understood by considering the following detailed description in conjunction with the accompanying drawings, in which:

FIG. 1 illustrates one example of a system related to the present disclosure;

FIG. 2 illustrates an example architecture for machine learning model-based fraud detection, e.g., for telecommunication network service provider retail store customer transactions, in accordance with the present disclosure;

FIG. 3 illustrates a flowchart of an example method for generating an alert in response to detecting that a first characteristic of data of a first data source associated with an input feature of a first machine learning model exceeds a forecast upper bound or a forecast lower bound of the first characteristic for a first time period; and

FIG. 4 illustrates a high-level block diagram of a computing device specially programmed to perform the functions described herein.

To facilitate understanding, identical reference numerals have been used, where possible, to designate identical elements that are common to the figures.

### DETAILED DESCRIPTION

The present disclosure broadly discloses methods, non-transitory (i.e., tangible or physical) computer-readable storage media, and apparatuses for generating an alert in response to detecting that a first characteristic of data of a first data source associated with an input feature of a first machine learning model exceeds a forecast upper bound or a forecast lower bound of the first characteristic for a first time period. To illustrate, in a typical machine learning (ML) pipeline, different machine learning models (MLMs) are analyzed using training data and the best performing model is selected. In general, the accuracy or performance of a model depends on the data used to train the model. To illustrate, a machine learning prediction flow may involve: (1) retrieving data from a database, e.g., a non-Structured Query Language (SQL)-based database, such as MongoDB, a SQL-based database, etc. In many cases, the data obtained may be noisy and need to be preprocessed; (2) converting data types, e.g., manipulating the data into appropriate form(s) to permit feature engineering to be applied to the data; (3) feature engineering—a process of manipulating the data retrieved from the database, which may involve removing or adding attributes, normalizing attribute data to a similar scale, etc.; (4) prediction, e.g., feeding the processed data to the MLM and acquiring results; (5) constructing a response—the form of the output may depend on the type of the ML task for which the MLM is adapted, as well as the type of response expected by a consuming application.

As referred to herein, a machine learning model (MLM) (or machine learning-based model) may comprise a machine learning algorithm (MLA) that has been “trained” or configured in accordance with input data (e.g., training data) to perform a particular service (e.g., a prediction task, such as to detect fraud and/or to provide a fraud indicator, or value indicative of a likelihood of fraud). As also referred to herein an MLM may refer to an untrained MLM (e.g., an MLA that is ready to be trained in accordance with appropriately formatted data). Examples of the present disclosure are not limited to any particular type of MLA/model, but are broadly applicable to various types of MLAs/models that utilize training data, such as support vector machines (SVMs), e.g., linear or non-linear binary classifiers, multi-class classifiers, deep learning algorithms/models, decision tree algorithms/models, e.g., a decision tree classifier, k-nearest neighbor (KNN) clustering algorithms/models, a gradient boosted or gradient descent algorithm/model, such as an a gradient boosted machine (GBM), an XGBoost-based model, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. In one example, a fraud detection MLM of the present disclosure may be in accordance with a MLA/MLM from an open source library, such as OpenCV, which may be further enhanced with domain specific training data.

Machine learning models may be used for a variety of prediction tasks in telecommunication networks. For instance, one or more machine learning models may be for predicting a level of demand for particular content items or a category of content items (e.g., 4K video, major television broadcast events, such as major national sporting events, a popular television series with a regularly scheduled broadcast times, etc.), which may be used for content distribution network (CDN) node placement, content preplacement at one or more edge nodes, or the like. Another machine learning model, or models, may be for predicting network traffic volumes for backbone links in a nationwide Multi-Protocol Label Switching (MPLS) network, which may be used for link load balancing, network traffic rerouting and so forth. Still another machine learning model, or models, may be for network intrusion detection, botnet activity detection, denial of service (DoS) attack detection, email or text spam activity detection, fraud detection, and so on.

For instance, telecommunication network service providers may have large retail distribution channels, and may have frequent attempts of fraudulent purchases from physical stores. As such, one or more machine learning models may be deployed in the telecommunication network to detect these fraudulent purchases, e.g., by providing a propensity (probability) of fraud for each occurrence (broadly, a “fraud score”). Other types of fraud or unauthorized use of the telecommunication network or its equipment may include account or subscriber identity module (SIM) hacking, the latter of which can result not only in an inconvenience for an affected legitimate subscriber associated with the SIM, but potential safety issues for those who rely upon the cellular network for critical services. Over time, the performance of a machine learning model may decline due to environmental or situational changes, such as fraudsters learning new techniques to avoid detection.

In one example, the telecommunication network may include a trained machine learning model (MLM), e.g., a fraud detection model, such as a gradient boosted machine (GBM), that outputs a fraud indicator value. In one example, the MLM comprises a plurality of independent variables associated with a plurality of input features and a dependent variable comprising a fraud indicator value. To illustrate, the plurality of input features may include features that may be obtained via the telecommunication network service provider network, including: geo-temporal features (e.g., which retail stores were visited by a customer, the distance between retail stores when the customer created or revised their shopping cart), a cart size (e.g., a total number, or quantity of items in a “shopping cart”), a count of particular items of interest (e.g., how many phones of a particular make and model), type(s) of items of interest (e.g., a category, or categories of the items, such as whether smart phones of interest are the latest, most recently released model(s)), price (which may include the overall value of items in the “shopping cart,” the value of the most expensive item in the “shopping cart,” etc.), desirability (e.g., whether the item(s) is/are the most popular or most expensive at the time, such as the current most expensive smart phone, the current most expensive wearable computing device, etc.), and so forth.

In one example, the plurality of features may include information derived from call detail records (CDRs) of the telecommunication network. For instance, when a customer provides a phone number as additional identification in connection with a transaction at a retail location, the present disclosure may obtain information regarding a level of utilization of the phone number. For example, the CDRs include records of caller and callee phone numbers, as long as one party to the call is a subscriber of the telecommunication network service provider. For a large telecommunication network service provider, the CDRs will include all calls for a phone number associated with a subscriber within a time range over which the CDRs are stored. In addition, for a non-subscriber phone number, the CDRs may still include a number of CDRs relating to the non-subscriber phone number, assuming “normal” usage. For instance, a non-fraudulent, non-subscriber user having a phone number is still likely to have a significant number of calls involving other parties who are already subscribers of the telecommunication network service provider. In any case, a low number of calls involving a phone number (as determined from the CDRs) although not a dispositive factor, may be associated with a fraudulent intent. In one example, the input features of an example fraud detection machine learning model may include whether or not the phone number is of a current subscriber, and may have separate factors for CDR call volume for current subscribers and non-subscribers, respectively. In one example, the plurality of factors (also referred to as “features” or “descriptors”) may also include information regarding the temporary or transient usage of resources (e.g., port-in number history and usage or the use of burner phones).

The plurality of factors may also relate to third party information, such as credit worthiness/credit score, recency of contact information, and so forth. In accordance with the present disclosure, recency of contact information may include when an email address was created, and therefore how long the email address has been in use, and may alternatively or additionally include information regarding whether and to what extent the same email address has been provided in connection with other transactions with third parties (including purchasing of goods or services, account creation, signing up for rewards or newsletters, etc.). In one example, recency information regarding a customer-provided phone number may also be obtained from an account management system of the telecommunication network, or from one or more third-parties, such as another telecommunication network, a merchant (e.g., where the phone number is provided in connection with a different transaction with such a third party merchant), and so on.

Based on a predefined threshold, the output of an example fraud detection MLM (e.g., a “propensity” or fraud score) may be high enough to prevent the completion of a transaction at a retail location between a customer and the telecommunication network service provider involving one or more items of interest. For instance, when the fraud score exceeds the threshold, a warning may be presented to a device at the first retail location when it is determined that the fraud indicator value meets the warning threshold, where the warning indicates a need to prevent a completion of a transaction between the customer and the telecommunication network service provider involving one or more items. In addition, the telecommunication network may include a number of alternate MLMs for a same prediction task, such as a type of fraud detection, and different machine learning models for performing a variety of different prediction tasks, such as other types of fraud detection, network performance monitoring and alerting, self-optimizing network (SON) and/or software defined network (SDN) configuration, and so on.

In one example, in accordance with the present disclosure, a machine learning pipeline may have three main points at which data quality may be inspected to ensure that the conditions appropriate for classification or inference are met: raw input data stage, processed/enhanced data (features or attributes to be scored or modeled) stage, and outcome values (e.g., categories or scores) stage. Examples of the present disclosure ensure the quality of the data that flows through the machine learning pipelines by detecting any type of problematic data point and disabling such data point(s) from the training and scoring processes. For instance, in one example, each dataset, or data source, may be characterized by an expected volume, a value distribution, a data type distribution, a number of clusters per column, and/or other metrics that represent a reliable dataset at a given time. In other words, the data of each data source may be defined by one or more characteristics. In one example, the present disclosure may also provide for the inclusion of new metrics, or characteristics, which may further describe the data of a data source.

In one example, a current set or stream of data of a raw data source may be compared with expected reference volumes, distributions of values, distribution of detected data types, etc., and similarly for other raw data sources. In one example, any outlier data source(s) may be disabled for use as training data for training one or more machine learning models, and may alternatively or additionally be disabled for use in prediction (e.g., for a deployed machine learning model, or models). Similarly, a current set or stream of data of an processed/enhanced data source may be compared with expected reference volumes, distributions of values, distribution of detected data types, etc., and similarly for other processed/enhanced data sources. Likewise, any outlier data source(s) may be disabled for use as training data for training one or more machine learning models, and may alternatively or additionally be disabled for use in prediction (e.g., for a deployed machine learning model, or models). An example of a processed/enhanced data source may comprise a set of radio access network utilization metrics, where the metrics may be for an area or zone of a cellular network portion of the telecommunication network, and where the metrics may be gathered from multiple serving gateways. For instance, each serving gateway may comprise a separate raw data source, and the aggregated data may be accumulated as a processed/enhanced data source. Another example of a processed/enhanced data source may comprise a data set comprising items sampled from one or more input (raw) data sources (e.g., randomly sampled, uniformly sampled, etc.), a data set comprising a moving average, exponentially weighted moving average, or other set of values calculated from one or more input data sources. In addition to the foregoing, the present disclosure may also monitor the prediction accuracy of one or more machine learning models, to detect when there is “drift” in the model(s) predictions, e.g., to trigger retraining, selection of an alternative machine learning model, or models, etc.

In one example, when a new raw data source is introduced to the system, the data source may be labeled by its “properties” or “expected” characteristics. The expected characteristics may then be loaded into an “expected reference store.” In one example, the present disclosure may automatically run a set of queries and algorithms over the new data source to obtain basic descriptive metrics for structured data (e.g., a number of fields, type of data per field, hourly volume time series per field, daily volume time series per field, hourly, daily, weekly value distributions (continuous), hourly, daily, weekly histogram (categorical), and so forth. The present disclosure may also generate data type predictions for structured or unstructured data, such as: primitive data types, latitude/longitude, social security number (SSN), email address, name(s), address(es), etc. In addition, the present disclosure may measure data type distributions for unstructured data, data type distributions for structured data, perform data clustering (e.g., per feature and/or per column of data), such as automatic clustering of individual fields data and obtaining a cluster distribution, and so on.

In one example, the initial results of all of these algorithms and queries may be reviewed and validated (e.g., by a data science or deployment team). Once validated the results may become the “expected properties”/reference properties for that particular data source/dataset. As noted above, at runtime, the expected properties may be used as a reference to identify situations where runtime characteristics, or properties of a data source are far away from the expected values. For example, anomalies (or outliers) may be flagged and disabled for training and/or scoring, and may also be sent to a data investigation team. In one example, the present disclosure may also provide a dataset investigation and labeling tool to enable labeling of specific data sets, specific fields, specific data ranges, etc. The labels can be used for several purposes, but in the context of the present disclosure, such labels may be specifically relevant to enable the use of particular data for training or scoring when the data is close enough to the expected reference, or conversely to disable the use of particular data for training or scoring when the data is far away from the expected reference.

Types of characteristics of a data source (or data of the data source) may comprise a data volume per time period of the data source and data values of the data of the data source. Another characteristic may comprise a percentage of null values of the data of the data source. For instance, it may be expected that for a non-required field of an online form, a customer questionnaire, or the like, at least some entries may be blank/null. For example, if an email address is not required to be provided to complete a transaction, some customers may decline to provide an email address, while others may have no problem to volunteer such information. Still other characteristics may include a number of clusters of the data of the data source (e.g., per column of data, or the like, and for a given time period, where any appropriate clustering algorithm/model may be used), a data type distribution of the data of the data source (e.g., a data source may have unstructured data such as entries typed by users into a form field, which can lead to a data type distribution), and so on.

In one example, for each characteristic of interest for a data source, the present disclosure may generate a forecast upper bound and a forecast lower bound for a time period (e.g., a next and/or upcoming day or other time period) for the characteristic using a time series forecast model. For instance, time series forecast models may be retrained nightly for each characteristic, or for an upper bound and a lower bound for each characteristic, respectively (e.g., these forecast upper and lower bounds may be the “expected characteristics” for the data source). In one example, a time series forecast model may comprise a seasonal naïve (S-Naïve) model, a seasonal decomposition model, an autoregressive model, a moving average model, an exponential smoothing model, or a dynamic linear model. Similarly, a time series forecast model may comprise a Facebook® Prophet model, an autoregressive integrated moving average model (ARIMA), a seasonal ARIMA (SARIMA) model, a neural network auto-regression (NNETAR) model, a recurrent neural network (RNN) model, and so forth. In addition, it should be noted that while a same time series forecast model may be used for forecasting expected upper and/or lower bounds for different characteristics of data of a data source, or different characteristics of different data sources, the parameters (e.g., “tuning” parameters) may be set differently. For instance, for a data source known to not experience a strong seasonality, the seasonality factor of a SARMIA model may be weighted less than for a data source that is known to experience a strong seasonality. Similarly, using a Prophet model, for a data source without a strong holiday influence, the holiday factor may be de-weighted, e.g., as compared to when the model may be used for forecasting upper and lower bounds for a characteristic of a data source having a highly skewed holiday influence (such as Black Friday purchases, or the like).

Using these forecast upper and lower bounds for each characteristic, as noted above, a current set or stream of data of a raw or enhanced data source may be compared with expected reference volumes, distributions of values, distribution of detected data types, etc., and similarly for characteristics of other data sources. In one example, any outlier data source(s) exceeding any one or more of these upper or lower bounds for one or more characteristics may be disabled for use as training data for training one or more MLMs, and may alternatively or additionally be disabled for use in prediction (e.g., for a deployed MLM, or multiple MLMs). For instance, when a data source is disabled for training, at least one input factor/feature provided by the data source may be eliminated. In other words, if each training example included 40 features, each training example may now include 39 features, with one of the features having been eliminated. Similarly, when a feature is disabled for prediction, data regarding an example being input to the machine learning model (e.g., factors of a customer or transaction being evaluated for fraud) may purposefully exclude data from the data source being disabled.

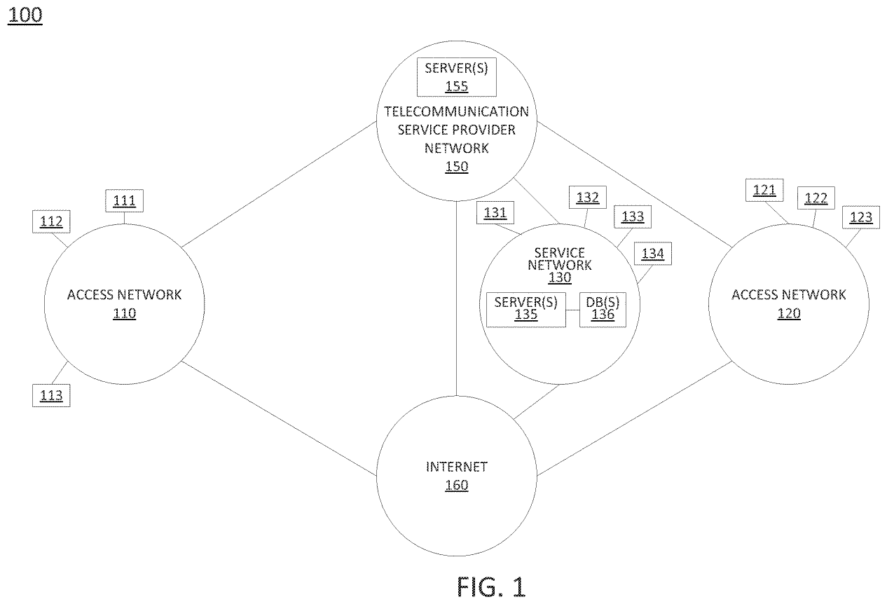

Thus, examples of the present disclosure ensure the quality of machine learning models predictions by applying a triple multi-dimensional verification process. The quality of data ingestion is verified by checking the quality of the input data (raw data sources). The quality of the feature generation process is verified by checking the quality of the intermediate features or attributes. In addition, the quality of the modeling phase is verified by checking the distribution of the final results or scores produced by the machine learning models. These and other aspects of the present disclosure are discussed in greater detail below in connection with the examples of FIGS. 1-4.

To aid in understanding the present disclosure, FIG. 1 illustrates an example system 100 comprising a plurality of different networks in which examples of the present disclosure may operate. Telecommunication service provider network 150 may comprise a core network with components for telephone services, Internet services, and/or television services (e.g., triple-play services, etc.) that are provided to customers (broadly “subscribers”), and to peer networks. In one example, telecommunication service provider network 150 may combine core network components of a cellular network with components of a triple-play service network. For example, telecommunication service provider network 150 may functionally comprise a fixed-mobile convergence (FMC) network, e.g., an IP Multimedia Subsystem (IMS) network. In addition, telecommunication service provider network 150 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Telecommunication service provider network 150 may also further comprise a broadcast television network, e.g., a traditional cable provider network or an Internet Protocol Television (IPTV) network, as well as an Internet Service Provider (ISP) network. With respect to television service provider functions, telecommunication service provider network 150 may include one or more television servers for the delivery of television content, e.g., a broadcast server, a cable head-end, a video-on-demand (VoD) server, and so forth. For example, telecommunication service provider network 150 may comprise a video super hub office, a video hub office and/or a service office/central office.

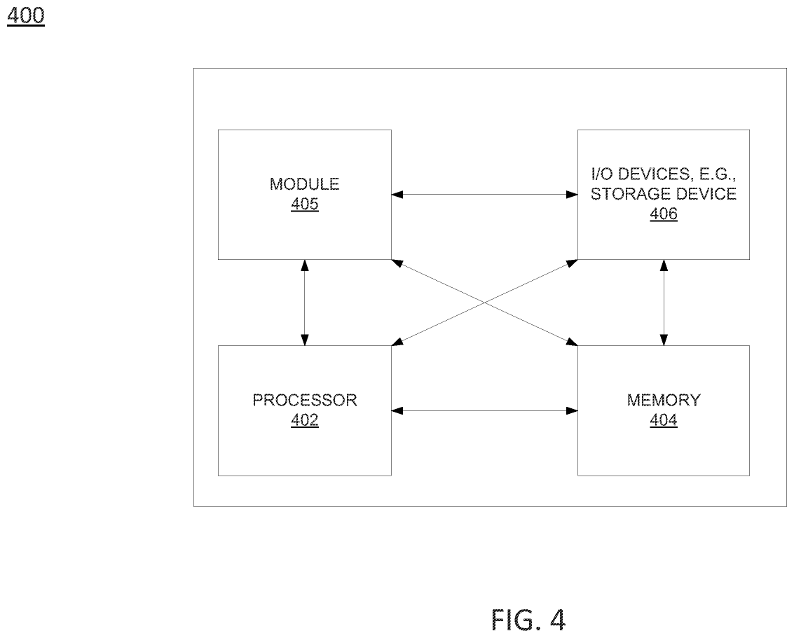

In one example, telecommunication service provider network 150 may also include one or more servers 155. In one example, the servers 155 may each comprise a computing device or system, such as computing system 400 depicted in FIG. 4, and may be configured to host one or more centralized and/or distributed system components. For example, a first system component may comprise a database of assigned telephone numbers, a second system component may comprise a database of basic customer account information for all or a portion of the customers/subscribers of the telecommunication service provider network 150, a third system component may comprise a cellular network service home location register (HLR), e.g., with current serving base station information of various subscribers, and so forth. Other system components may include a Simple Network Management Protocol (SNMP) trap, or the like, a billing system, a customer relationship management (CRM) system, a trouble ticket system, an inventory system (IS), an ordering system, an enterprise reporting system (ERS), an account object (AO) database system, and so forth. In addition, other system components may include, for example, a layer 3 router, a short message service (SMS) server, a voicemail server, a video-on-demand server, a server for network traffic analysis, and so forth. It should be noted that in one example, a system component may be hosted on a single server, while in another example, a system component may be hosted on multiple servers in a same or in different data centers or the like, e.g., in a distributed manner. For ease of illustration, various components of telecommunication service provider network 150 are omitted from FIG. 1.

In one example, access networks 110 and 120 may each comprise a Digital Subscriber Line (DSL) network, a broadband cable access network, a Local Area Network (LAN), a cellular or wireless access network, and the like. For example, access networks 110 and 120 may transmit and receive communications between endpoint devices 111-113, endpoint devices 121-123, and service network 130, and between telecommunication service provider network 150 and endpoint devices 111-113 and 121-123 relating to voice telephone calls, communications with web servers via the Internet 160, and so forth. Access networks 110 and 120 may also transmit and receive communications between endpoint devices 111-113 and 121-123 and other networks and devices via Internet 160. For example, one or both of the access networks 110 and 120 may comprise an ISP network, such that endpoint devices 111-113 and/or 121-123 may communicate over the Internet 160, without involvement of the telecommunication service provider network 150. Endpoint devices 111-113 and 121-123 may each comprise a telephone, e.g., for analog or digital telephony, a mobile device, such as a cellular smart phone, a laptop, a tablet computer, etc., a router, a gateway, a desktop computer, a plurality or cluster of such devices, a television (TV), e.g., a “smart” TV, a set-top box (STB), and the like. In one example, any one or more of endpoint devices 111-113 and 121-123 may represent one or more user devices (e.g., subscriber/customer devices) and/or one or more servers of one or more third parties, such as a credit bureau, a payment processing service (e.g., a credit card company), an email service provider, and so on.

In one example, the access networks 110 and 120 may be different types of access networks. In another example, the access networks 110 and 120 may be the same type of access network. In one example, one or more of the access networks 110 and 120 may be operated by the same or a different service provider from a service provider operating the telecommunication service provider network 150. For example, each of the access networks 110 and 120 may comprise an Internet service provider (ISP) network, a cable access network, and so forth. In another example, each of the access networks 110 and 120 may comprise a cellular access network, implementing such technologies as: global system for mobile communication (GSM), e.g., a base station subsystem (BSS), GSM enhanced data rates for global evolution (EDGE) radio access network (GERAN), or a UMTS terrestrial radio access network (UTRAN) network, among others, where telecommunication service provider network 150 may provide service network 130 functions, e.g., of a public land mobile network (PLMN)-universal mobile telecommunications system (UMTS)/General Packet Radio Service (GPRS) core network, or the like. Thus, access networks 110 and 120 may include a number of components (omitted from FIG. 1 for clarity and ease of illustration), such as base stations, eNodeBs, gNodeBs, or the like, baseband units (BBUs), remote radio heads (RRHs), and so on, while telecommunication service provider network 150 may further comprise serving gateways (SGWs), packet data network gateways (PGWs), mobility management entities (MMEs), network slice selection functions (NSSFs), and so on (also omitted from FIG. 1 for clarity and ease of illustration). In still another example, access networks 110 and 120 may each comprise a home network or enterprise network, which may include a gateway to receive data associated with different types of media, e.g., television, phone, and Internet, and to separate these communications for the appropriate devices. For example, data communications, e.g., Internet Protocol (IP) based communications may be sent to and received from a router in one of the access networks 110 or 120, which receives data from and sends data to the endpoint devices 111-113 and 121-123, respectively.

In this regard, it should be noted that in some examples, endpoint devices 111-113 and 121-123 may connect to access networks 110 and 120 via one or more intermediate devices, such as a home gateway and router, an Internet Protocol private branch exchange (IPPBX), and so forth, e.g., where access networks 110 and 120 comprise cellular access networks, ISPs and the like, while in another example, endpoint devices 111-113 and 121-123 may connect directly to access networks 110 and 120, e.g., where access networks 110 and 120 may comprise local area networks (LANs), enterprise networks, and/or home networks, and the like.

In one example, the service network 130 may comprise a local area network (LAN), or a distributed network connected through permanent virtual circuits (PVCs), virtual private networks (VPNs), and the like for providing data and voice communications. In one example, the service network 130 may be associated with the telecommunication service provider network 150. For example, the service network 130 may comprise one or more devices for providing services to subscribers, customers, and/or users. For example, telecommunication service provider network 150 may provide a cloud storage service, web server hosting, and other services. As such, service network 130 may represent aspects of telecommunication service provider network 150 where infrastructure for supporting such services may be deployed.

In one example, the service network 130 links one or more devices 131-134 with each other and with Internet 160, telecommunication service provider network 150, devices accessible via such other networks, such as endpoint devices 111-113 and 121-123, and so forth. In one example, devices 131-134 may each comprise a telephone for analog or digital telephony, a mobile device, a cellular smart phone, a laptop, a tablet computer, a desktop computer, a bank or cluster of such devices, and the like. In an example where the service network 130 is associated with the telecommunication service provider network 150, devices 131-134 of the service network 130 may comprise devices of network personnel, such as customer service agents, sales agents, marketing personnel, or other employees or representatives who are tasked with addressing customer-facing issues and/or personnel for network maintenance, network repair, construction planning, and so forth.

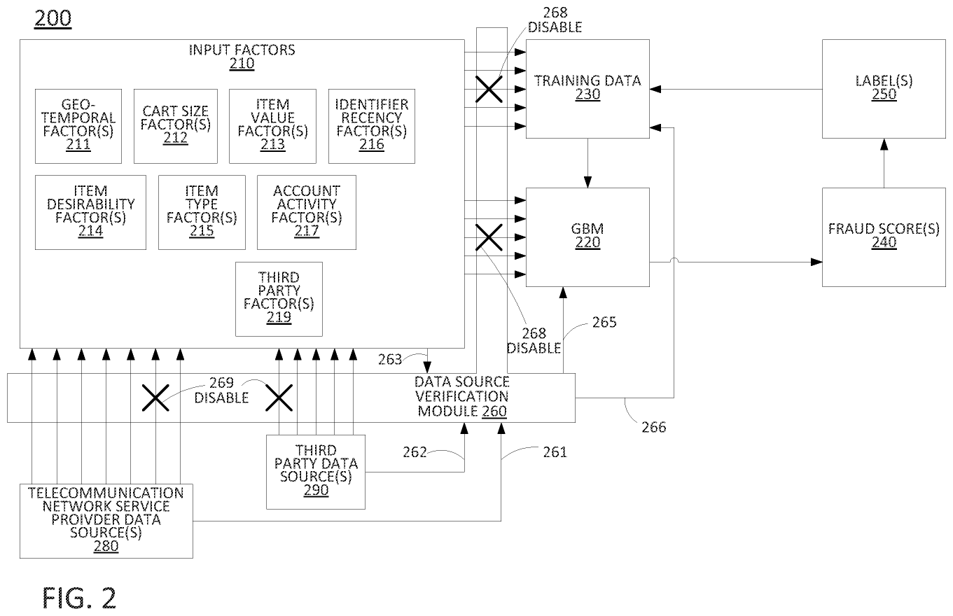

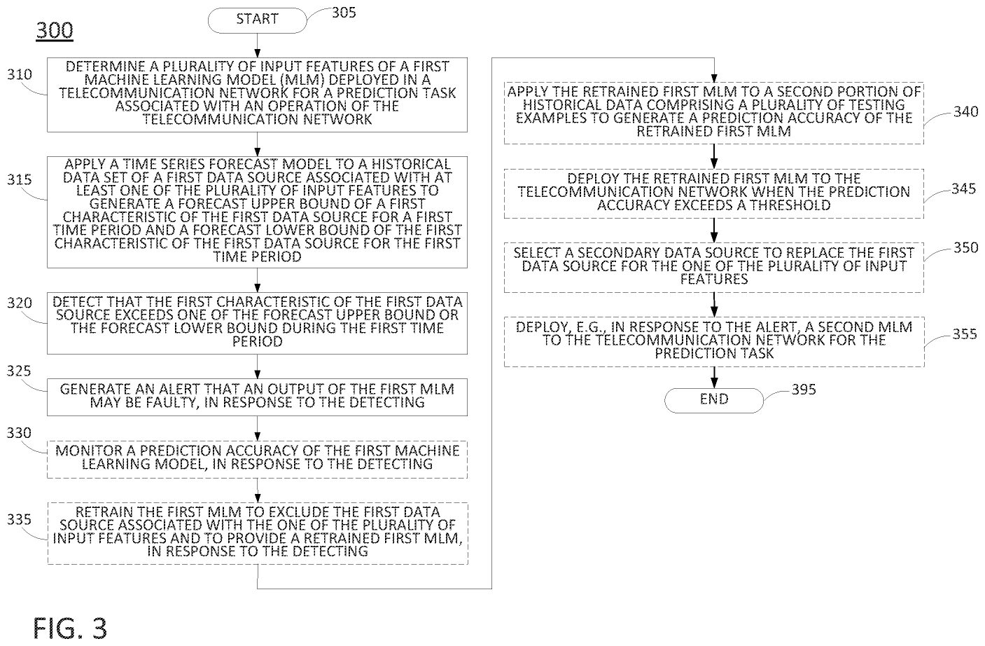

In the example of FIG. 1, service network 130 may include one or more servers 135 which may each comprise all or a portion of a computing device or processing system, such as computing system 400, and/or a hardware processor element 402 as described in connection with FIG. 4 below, specifically configured to perform various steps, functions, and/or operations for generating an alert in response to detecting that a first characteristic of data of a first data source associated with an input feature of a first machine learning model exceeds a forecast upper bound or a forecast lower bound of the first characteristic for a first time period, as described herein. For example, one of the server(s) 135, or a plurality of servers 135 collectively, may perform operations in connection with the example architecture 200 of FIG. 2 and/or the example method 300 of FIG. 3, or as otherwise described herein. In one example, the one or more of the servers 135 may comprise an MLM-based service platform (e.g., a network-based and/or cloud-based service hosted on the hardware of servers 135).

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device, or computing system, including one or more processors, or cores (e.g., as illustrated in FIG. 4 and discussed below) or multiple computing devices collectively configured to perform various steps, functions, and/or operations in accordance with the present disclosure.

In one example, service network 130 may also include one or more databases (DBs) 136, e.g., physical storage devices integrated with server(s) 135 (e.g., database servers), attached or coupled to the server(s) 135, and/or in remote communication with server(s) 135 to store various types of information in support of systems for generating an alert in response to detecting that a first characteristic of data of a first data source associated with an input feature of a first machine learning model exceeds a forecast upper bound or a forecast lower bound of the first characteristic for a first time period, as described herein. As just one example, DB(s) 136 may be configured to receive and store network operational data collected from the telecommunication service provider network 150, such as call logs, mobile device location data, control plane signaling and/or session management messages, data traffic volume records, call detail records (CDRs), error reports, network impairment records, performance logs, alarm data, and other information and statistics, which may then be compiled and processed, e.g., normalized, transformed, tagged, etc., and forwarded to DB(s) 136, via one or more of the servers 135.

In one example, DB(s) 136 may be configured to receive and store records from customer, user, and/or subscriber interactions, e.g., with customer facing automated systems and/or personnel of a telecommunication network service provider (e.g., the operator of telecommunication service provider network 150). For instance, DB(s) 136 may maintain call logs and information relating to customer communications which may be handled by customer agents via one or more of the devices 131-134. For instance, the communications may comprise voice calls, online chats, etc., and may be received by customer agents at devices 131-134 from one or more of devices 111-113 and 121-123, etc. The records may include the times of such communications, the start and end times and/or durations of such communications, the touchpoints traversed in a customer service flow, results of customer surveys following such communications, any items or services purchased, the number of communications from each user, the type(s) of device(s) from which such communications are initiated, the phone number(s), IP address(es), etc. associated with the customer communications, the issue or issues for which each communication was made, etc. Alternatively, or in addition, any one or more of devices 131-134 may comprise an interactive voice response system (IVR) system, a web server providing automated customer service functions to subscribers, etc. In such case, DB(s) 136 may similarly maintain records of customer, user, and/or subscriber interactions with such automated systems. The records may be of the same or a similar nature as any records that may be stored regarding communications that are handled by a live agent.

Similarly, any one or more of devices 131-134 may comprise a device deployed at a retail location that may service live/in-person customers. In such case, the one or more of devices 131-134 may generate records that may be forwarded and stored by DB(s) 136. The records may comprise purchase data, information entered by employees regarding inventory, customer interactions, surveys responses, the nature of customer visits, etc., coupons, promotions, or discounts utilized, and so forth. In this regard, any one or more of devices 111-113 or 121-123 may comprise a device deployed at a retail location that may service live/in-person customers and that may generate and forward customer interaction records to DB(s) 136. For instance, such a device (e.g., a “personnel device”) may comprise a tablet computer in which a retail sales associate may input information regarding a customer and details of the transaction, such as identity and contact information provided by the customer (e.g., a name, phone number, email address, mailing address, etc.), desired items (e.g., physical items, such as smart phones, phone cases, routers, tablet computers, laptop computers, etc., or service items, such as a new subscription or a subscription renewal, a type of subscription (e.g., prepaid, non-prepaid, etc.), an agreement duration (e.g., a one-year contract, a two-year contract, etc.), add-on services (such as additional data allowances, international calling plans, and so forth), discounts to be applied (such as free phone upgrades and/or subsidized phone upgrades, special group discounts, etc.), and so on. In such case, information entered and/or obtained via such personnel devices may be forwarded to server(s) 135 and/or DB(s) 136 for processing and/or storage. As such, DB(s) 136, and/or server(s) 135 in conjunction with DB(s) 136, may comprise a retail inventory management knowledge base. In addition, DB(s) 136 and/or server(s) 135 in conjunction with DB(s) 136 may comprise an account management system. For instance, information regarding subscribers' online and in-store activities may also be included in subscriber account records (e.g., in addition to contact information, payment information, information on current subscriptions, authorized users, duration of contract, etc.).

In one example, DB(s) 136 may alternatively or additionally receive and store data from one or more third parties. For example, one or more of endpoint devices 111-113 and/or 121-123 may represent a server, or servers, of a consumer credit entity (e.g., a credit bureau, a credit card company, etc.), a merchant, or the like. In such an example, DB(s) 136 may obtain one or more data sets/data feeds comprising information such as: consumer credit scores, credit reports, purchasing information and/or credit card payment information, credit card usage location information, and so forth. In one example, one or more of endpoint devices 111-113 and/or 121-123 may represent a server, or servers, of an email service provider, from which DB(s) 136 may obtain email address service information (e.g., high-level information, such as the date the email address was created and or an age or approximate age of the email address since it was created, a mailing address and/or phone number (if any) that is associated with the email address (and if the third party is permitted to provide such information in accordance with the email address owner's permissions). Such information may then be leveraged in connection with email addresses that may be provided by customers during in-person transactions at telecommunication network service provider retail locations. Similarly, one or more of endpoint devices 111-113 and/or 121-123 may represent a server, or servers, of one or more merchants or other entities (such as entities providing ticketed sporting events and/or concerts, email mailing lists, etc.), from which DB(s) 136 may obtain additional email address information (e.g., email address utilization information).

As such, DB(s) 136 may represent any raw data sources and/or enhanced/processed data sources that may be associated with input factors of various machine learning models (MLMs) for a variety of prediction tasks in the system 100. For illustrative purposes, examples are described herein primarily in connection with fraud detection. However, it should be understood that other, further, and different examples may relate to MLMs for self-optimizing network (SON) and/or software defined network (SDN) configuration, network performance monitoring and alerting, and so on. In this regard, data from DB(s) 136 may comprise input factors to a variety of MLMs, e.g., a MLM for fraud detection (broadly, a “fraud detection machine learning model”) as described herein. To illustrate, a MLM for fraud detection may have 30 factors, each of which may be associated with a different data source, or which may be associated with several data sources, each data source providing one or more of the input factors (e.g., multiple input factors may be obtained from different fields from a same data source). For instance, to evaluate a customer, endpoint device, transaction, etc. for fraud, values for the 30 input factors may be gathered relating to the subject being evaluated/scored (e.g., the customer, endpoint device, transaction, etc.). Thus, the values for these 30 factors may comprise an “example” to be evaluated/scored. In one example, a record or “set of inputs” for each “example” may be compiled and stored in DB(s) 136. In another example, these values may be gathered at runtime, e.g., pulled from the respective data sources, and input to the MLM.

Similarly, values for the 30 input factors may be gathered and/or stored in DB(s) 136 relating to each of a plurality of training examples and/or testing examples that may be used to train and verify the accuracy of a MLM for fraud detection (broadly, a “fraud detection machine learning model”) as described herein. For instance, sets of inputs (e.g., factors/features) relating to in-person transactions at a retail location of a telecommunication network service provider may be stored in connection with the associated predictions (fraud scores). In addition, labels may be added to at least a portion of the stored sets of input factors (e.g., labels of “fraud” or “no fraud”) as stored in DB(s) 136. In one example, server(s) 135 and/or DB(s) 136 may comprise cloud-based and/or distributed data storage and/or processing systems comprising one or more servers at a same location or at different locations. For instance, DB(s) 136, or DB(s) 136 in conjunction with one or more of the servers 135, may represent a distributed file system, e.g., a Hadoop® Distributed File System (HDFS™), or the like.

In accordance with the present disclosure server(s) 135 may run trained machine learning models (MLMs) in deployment, e.g., for ongoing predictive tasks. In addition, server(s) 135 may train and test such MLMs, may model characteristics of the data sources for expected upper and lower bounds, may evaluate current characteristics of the data source with regard to the expected upper and lower bounds, may alert and/or disable data sources having a characteristic, or characteristics, that is/are out-of-bounds for training or testing of one or more machine learning models (and/or for the ongoing predictions in deployment), and so on. Operations of server(s) 135 for generating an alert in response to detecting that a first characteristic of data of a first data source associated with an input feature of a first machine learning model exceeds a forecast upper bound or a forecast lower bound of the first characteristic for a first time period, and/or server(s) 135 in conjunction with one or more other devices or systems (such as DB(s) 136) are further described below in connection with the examples of FIGS. 2 and 3.

In addition, it should be realized that the system 100 may be implemented in a different form than that illustrated in FIG. 1, or may be expanded by including additional endpoint devices, access networks, network elements, application servers, etc. without altering the scope of the present disclosure. As just one example, any one or more of server(s) 135 and DB(s) 136 may be distributed at different locations, such as in or connected to access networks 110 and 120, in another service network connected to Internet 160 (e.g., a cloud computing provider), in telecommunication service provider network 150, and so forth. Thus, these and other modifications are all contemplated within the scope of the present disclosure.

FIG. 2 illustrates an example architecture 200 for machine learning model maintenance and deployment, in accordance with the present disclosure. In one example, the architecture 200 may be implemented via a processing system comprising one or more physical devices and/or components thereof, such as a server or a plurality of servers, a database system, and so forth. For instance, various aspects of the architecture 200 may be provided via components as illustrated FIG. 1, including server(s) 135 and/or DB(s) 136, server(s) 155, endpoint devices 111-113 and 121-123, devices 131-134, etc. It should again be noted that while the present example is described primarily in connection with a fraud detection MLM for telecommunication network service provider retail store customer transactions (e.g., gradient boosted machine (GBM) 220), the present architecture 200 may additionally relate to MLMs of various types for SON/SDN configuration, network performance monitoring and alerting, and/or other types of fraud detection and prevention.

As shown in FIG. 2, the architecture 200 includes inputs from one or more telecommunication network service provider data sources 280, such as one or more data storage systems comprising a CDR database, a customer account database, a retail inventory management knowledge base, devices at retail locations of the telecommunication network service provider (e.g., “personnel devices”), etc. Similarly, the architecture 200 includes inputs from one or more third party data sources 290, such as credit bureaus providing credit score data, email service providers providing email address account information and usage information, merchants or other entities providing email address and/or phone number usage information (e.g., from various purchases of customers with such merchants, etc.), and so forth. These various telecommunication network service provider data sources 280 and third party data sources 290 may comprise “raw” data sources, or may comprise “processed”/“enhanced” data sources from which some of the underlying “raw” data may be lost, such as summary statistics, moving averages, sampled data points, anonymized data points (e.g., where age ranges may replace exact birthdates, zip codes only may replace full street addresses, etc.), outputs of other machine learning models (for instance third party data sources 290 may include the outputs of one or more machine learning models operated by third parties), and so on.

As further illustrated in FIG. 2, the architecture 200 may include assembling data from telecommunication network service provider data source(s) 280 and third party data source(s) 290 into a plurality of input factors 210. For instance, the input factors 210 may include one or more geo-temporal factors 211, one or more cart size factors 212, one or more item value factors 213, one or more item desirability factors 214, one or more item type factors 215, one or more identifier recency factors 216, one or more account activity factors 217, and one or more third party factors 219. The geo-temporal factor(s) 211 may include information that quantifies which retail stores a customer visited, the distance between the retail stores (e.g., when a customer has visited two or more retail stores in connection with a same transaction, or different transactions within a given time duration (e.g., within the same week, within the same month, etc.)). The cart size factor(s) 212 may comprise an indicator of a total number, or quantity of items in a “shopping cart” that is created for a customer. Insofar as the present disclosure relates to fraud detection for telecommunication network service provider retail locations, the “shopping cart” may be maintained as a list that is input via a device (e.g., of an in-store personnel of the telecommunication network service provider). The cart size factor(s) 212 may also include counts of particular items of interest (e.g., how many phones of a particular make and model are in the “shopping cart”). It should again be noted that the items of interest may include physical items as well as service items.

The item value factor(s) 213 may comprise prices (which may include the overall value of items in the “shopping cart,” the value of the most expensive item in the “shopping cart,” etc.). The item desirability factor(s) 214 may include indicators of whether the item(s) is/are the most popular or most expensive at the time within a particular category, such as the current most expensive smart phone, the current most expensive wearable computing device, a current most expensive subscription package, etc. (or within the top N items within a particular category in terms of value, such as within the top three most expensive phones, etc.). The item type factor(s) 215 may include type(s) of items of interest (e.g., a category, or categories of the items). The item type factor(s) 215 may also include one or more indicators of whether items of interest are the latest, most recently released model(s) (e.g., for physical items in the “shopping cart”).

The identifier recency factor(s) 216 may include information regarding the recency of contact information, such as when a customer-provided email address was created, and therefore how long the email address has been in use, and may alternatively or additionally include information regarding whether and to what extent the same email address has been provided in connection with other transactions with third parties (including purchasing of goods or services, account creation, signing up for rewards or newsletters, etc.). Another example is how long the customer has resided at an address of a residence.

In one example, identifier recency factor(s) 216 may include information regarding a customer-provided phone number that may be obtained from telecommunication network service provider data source(s) 280 (such as an account management system of the telecommunication network service provider), or from one or more third parties, such as another telecommunication network service provider, a merchant (e.g., where the phone number is provided in connection with a different transaction with such a third party merchant), and so on. It should also be noted that in one example, the item value factor(s) 213, the item desirability factor(s) 214, and the item type factor(s) 215 may comprise aggregate information combining information received from telecommunication network service provider data source(s) 280 and third party data source(s) 290. For instance, for one of the item value factor(s) 213 that may relate to a price of a particular phone make and model, the price/value of the item may be averaged from the overall sale prices for the particular phone make and model from direct sales by the telecommunication network service provider as well as sales of the same make and model of phone through third party channels.

The account activity factor(s) 217 may include information regarding account activity associated with one or more identifiers of a customer. For instance, account activity may include adding a line to the account, porting a phone number to the account, upgrading a physical device associated with the account, adding a physical device associated with the account, removing an association of a physical device with the account, or adding an authorized user to the account. Thus, for example, each one of these types of activities may have an associated factor that may indicate whether or not the activity has occurred with respect to the account within a predefined time period prior to a current in-person visit to a retail location of the telecommunication network service provider (e.g., within the past three days, the past week, the past two weeks, the past month, etc.). For instance, one or more of such factors may comprise binary factors (e.g., yes or no, with respect to whether the activity has occurred). In one example, such factors may accommodate a range of values such as from 0 to 14, indicating whether such an activity has occurred (e.g., zero indicating that the activity did not occur within the predefined time period prior to the in-person visit to the retail location, or 1-14, indicating how many days prior to the current in-person visit the account activity occurred, e.g., 1 being at a prior time on the same day, 2 being the immediately prior day, etc.). It should be noted that other data formats of the same or a similar nature may be utilized in various examples.

The third party factor(s) 219 may include a credit worthiness/credit score factor, one or more recency of contact information factors (dates of creation and/or times since creation of email addresses, dates and/or times since last assignment of a telephone numbers, (e.g., by another telecommunication network service provider, a mobile virtual network operator (MVNO), etc.) email address and/or telephone number usage in connection with transactions with third party merchants or other entities), and so forth. It should be noted that in one example, all or a portion of the information obtained from third party data source(s) 290 may be incorporated into other factors as noted above (e.g., item value factor(s) 213, item desirability factor(s) 214, and/or identifier recency factor(s) 216). However, in another example, information obtained from third party data source(s) 290 that may be the same as or similar to information obtained from telecommunication network service provider data source(s) 280 may nevertheless be provided in distinct factors (e.g., and referred to as third party factor(s) 219). For instance, in one example, identifier recency factor(s) may aggregate information from both of telecommunication network service provider data source(s) 280 and third party data source(s) 290, while in another example, information regarding recency of email addresses and/or phone numbers obtained from telecommunication network service provider data source(s) 280 may be included in identifier recency factor(s) 216 and information regarding recency of email addresses and/or phone numbers obtained from third party data source(s) 290 may have one or more separate factors that may be included in third party factor(s) 219.

In one example, the architecture 200 may include data preprocessing in connection with the formation of the input factors 210, such as data filtering, transformation, aggregation, and so forth. In addition, the input factors 210 may be organized and grouped on a per-transaction basis (or in other cases, per customer, per endpoint device, etc., broadly per “example”) into sets of input factors which may be used for training data 230 (including “testing” data), or for current evaluation via a gradient boosted machine (GBM) 220.

Architecture 200 further comprises a machine learning model (MLM) such as a gradient boosted machine (GBM) 220, e.g., a gradient boosted decision tree (GBDT), which is trained for and operates to output fraud scores regarding customer transactions at retail locations of the telecommunication network service provider. The GBM 220 may initially be trained with training data 230 (which is referred to herein may also include “testing” data that is used for verification of accuracy, or the like). For instance, the training data may include input factors 210 for various customer transactions which may be labeled, e.g., with labels 250 that may be obtained for past customer transactions for which an indicator of fraud or no fraud may be applied. For example, loss prevention personnel may investigate a sampling of customer transactions at some point in the future after such transactions are completed, and may provide manual labels of “fraud” or “no fraud.” In one example, the sets of input factors 210 for customer transactions involving known fraud may be manually labeled as such, while the sets of input factors 210 for customer transactions that are not known to involve fraud may be automatically labeled “no fraud” (and/or default labels of “no fraud” may be applied to these sets of input factors 210).

The GBM 220 may comprise a plurality of independent variables (e.g., input factors 210) and a dependent variable (e.g., the output/prediction, which in accordance with the present disclosure comprises a fraud score). Insofar as the input factors 210 of the present example are predefined, the GBM 220 is an example of supervised machine learning (ML). In addition, different parameters of the GBM 220 may be tuned. For instance, for a GBDT, a first decision tree may be trained and then a residual error may be detected. A second decision tree may be trained in accordance with the residual error, and so on. The number of trees created may be predefined (e.g., 10 trees, 50 trees, 100 trees, 200 trees, etc.) or may be reached when the residual error is below a predefined threshold, e.g., less than 15 percent, less than 10 percent, etc. As such, the number of trees and/or the predefined threshold are parameters that may be selected, or “tuned” by an operator of the telecommunication network service provider in view of any number of criteria, such as time and/or resources to train, a business judgement regarding a tolerability of false positives and/or missed fraudulent cases, a desire to avoid overfitting, etc. Similarly, the tree depth may be a configurable parameter of GBM 220, for instance a tree depth of 3, 5, 7, 10, etc. may be selected. In addition, a maximum number of nodes (including leaves) may be selected as a configurable parameter. Thus, while there may a larger number of input factors 210 from which to select, for each tree that is created, a lesser number of factors may be selected as observations in the tree (e.g., nodes and/or leaves). Other tunable parameters may be the loss improvement that is required in order to add a decision node (add a split to a tree), and so on.

In one example, each tree may be generated from the same training data 230. In another example, each tree may be generated from randomly sampled data from a same pool of the training data 230. The selection of full-set or sampling from the training data 230 may therefore comprise another tunable parameter. In addition, the accuracy of the GBM 220 may be calculated and improved using out-of-bag testing, bootstrap aggregating (bagging), cross validation, or the like. For instance, as each tree is created, the accuracy of the GBM 220 may be recalculated using the same or different testing data (e.g., from the training data 230). Thus, trees may be added as the accuracy continues to improve and/or until a maximum number of trees in reached. It should also be noted that the GBM 220, as deployed and in operation for fraud detection in a production environment, may also continue to be tested. The GBM 220 may be retrained periodically with new training data 230 and/or when the accuracy of the GBM 220 is observed to decline below a threshold (e.g., a threshold accuracy and/or a threshold decline from an accuracy since last retraining, etc.). For instance, the GBM 220 may be retrained when the accuracy falls below 75 percent, 70 percent, etc. For example, as new items become more popular or have been in the market for longer, as items are discounted, as promotional offers take effect, and so forth, circumstances may change such that the patterns in the input factors 210 that are most indicative of fraud will also dynamically change.

The GBM 220, in accordance with gradient boosting techniques, may output a value (e.g., the independent variable), which in the present example, comprises a fraud score (e.g., one of fraud score(s) 240). In one example, the GBM 220 may operate as a binary classifier and may be trained as such (in other words, the output fraud score(s) 240 may be one of two values indicating “fraud” or “no fraud”). In another example, the dependent variable (the output/fraud score(s) 240) may take a number of discrete values, or a range of continuous values indicative of fraud. As such, GBM 220 may comprise an ensemble of classification trees or regression trees, in respective examples. Thus, the fraud score(s) 240 may each comprise a percent or number that indicates the likelihood, or the relative likelihood that a particular customer transaction may be potentially fraudulent (e.g., a higher score may be more indicative of fraud, while not actually constituting a percentage likelihood). It should be noted that in accordance with gradient boosting techniques, the fraud score(s) 240 may be assembled from the predictions of each of the decision trees constituting the trained GBM 220. In one example, based upon post-observations (e.g., labeling), the GBM 220 may learn a percentage likelihood of fraud that may be mapped to the dependent variable/output value. In such case, the output of GBM 220 may comprise a translated fraud score. Thus, fraud score(s) 240 may comprise predictions of a percentage likelihood of fraud.

In one example, the fraud score(s) 240 may be provided to devices at retail locations (e.g., to the personnel devices being used by in-store retail associates serving customers in connection with particular customer transactions, to devices being used by supervisors or managers, etc.). Alternatively, or in addition, warnings or instructions may be transmitted to such devices for customer transactions for which fraud is indicated. For instance, in accordance with GBM 220 comprising a binary classifier, where the output indicates “fraud,” a warning or instruction may be provided. In accordance with GBM 220 employing classification trees having more diverse output values and/or regression trees, a warning or instruction may be provided when one of the fraud score(s) 240 exceeds a predefined threshold (e.g., indicating a likelihood of fraud greater than 50 percent, greater than 75 percent, greater than 95 percent, etc.). For example, the instruction may indicate to the retail associate that he or she is not authorized to complete the transaction, that the retail associate is to direct the customer to a supervisor who may engage in additional verification of the customer identity and/or intended method of payment, and so forth.

The application of labels 250 to the training data 230 is discussed above. In addition, in one example, the training data 230 may be specifically weighted such that sampling of the training data 230 for actual use in training the GBM 220 may favor examples for which the predictions/fraud score(s) 240 were incorrect according to the labels. For instance, if one of the fraud score(s) 240 is provided that is determined to exceed a threshold indicative of fraud, but the label indicates that there was no fraud, the associated input factors 210 (along with the label) may preferentially be used for additional training of the GBM 220.

It should be noted that architecture 200 is just one example logical arrangement that may be implemented via a processing system in accordance with the present disclosure. Accordingly, it should be understood that the features described in connection with FIG. 2 may include alternative or additional arrangements in accordance with the present disclosure. For instance, in other, further, and different examples, alternative machine learning models for fraud detection may be deployed in place of GBM 220, such as a DNN, an SVM, a GAN, and so forth. In addition, it should be understood that other aspects of a processing system implementing the architecture 200 may be omitted from illustration in FIG. 2. As just one example, the architecture 200 may include a data distribution platform for obtaining sets/streams from telecommunication network service provider data source(s) 280 and third party data source(s) 290, such as Apache Kafka, or the like.

The architecture 200 may also incorporate in-stream processing, such as preprocessing of the data comprising input factors 210 from telecommunication network service provider data source(s) 280 and third party data source(s) 290 (e.g., the input factors 210 may represent enhanced/processed data sources, which may be received already preprocessed, or which may be pre-processed after receiving from telecommunication network service provider data source(s) 280 and/or third party data source(s) 290). For example, the architecture 200 may be deployed on or more instances of Apache Flink, or the like, as part of and/or in association with the Kafka streaming platform. Similarly, input factors 210, training data 230, and so forth may be stored in a distributed data storage platform. In addition, the GBM 220 (or other fraud detection MLMs, or MLMs for other prediction tasks in accordance with the present disclosure) may be trained within and/or may operate on such a platform. For instance, the architecture 200 may comprise an instance of Apache Spark, e.g., on top of Hive and Hadoop Distributed File System (HDFS), or similar arrangement. Thus, these and other aspects are all contemplated within the scope of the present disclosure.

As noted above, examples of the present disclosure provide a verification of the integrity for data sources providing input factors to various MLMs. This may be represented by data source verification module 260 in FIG. 2. As shown in FIG. 2, data source verification module 260 may obtain historical data for a data source to determine expected characteristics, e.g., forecast upper and lower bounds for a first time period (e.g., a next day, another upcoming day, or the like) for each of a plurality of characteristics of data of the data source (and so on for a plurality of different data sources). The obtaining of such data is illustrated by the links 261-263. For example, the historical data may be obtained from the telecommunication network service provider data source(s) 280 and/or third party data source(s) 290, or may be obtained from the stored input factors 210, which may also include further enhanced/processed data sources that may be derived from the telecommunication network service provider data source(s) 280 and/or third party data source(s) 290. The forecasting may be in accordance with one or more time series forecast models. The parameters of the time series forecast models, such as the weights to apply to seasonal terms, holiday terms, etc., may be tuned differently depending upon the particular characteristic, the particular data source, and so on.

The data source verification module 260 may examine data for each data source (e.g., during the next day, as it occurs, or such other time period as to which the forecast upper and lower bounds are applicable) to determine values for the different characteristics of the data of the data source, e.g., data volume, data values, data type distributions, data inter-arrival time, number and/or rate of null value (blank) data, etc. When the data source verification module 260 detects that the characteristic of the data source is out of bounds (e.g., exceeds the forecast upper or lower bound, exceeds the forecast upper or lower bound for more than a certain duration of time, etc.), the data source verification module 260 may generate an alert that the output of any machine learning model depending upon the data source (e.g., GBM 220) may be faulty. For instance, the alert may be a warning label attached to fraud score(s) 240. Any user or application consuming the fraud score(s) 240 may therefore be informed that the fraud score(s) 240 may be inaccurate. In one example, the alert may be provided to network personnel who may further investigate any root cause, e.g., to determine whether the data source is truly faulty, and what the cause of fault is (such as a change in data format implemented by a third party providing the data source, a change in data frequency of the data collection of the data, source, etc.) or whether the data source is not faulty, but the data is substantially skewed for a different reason (such as fraudsters recently being able to avoid or manipulate a particular data point).

Alternatively, or in addition, data source verification module 260 may trigger a retraining of any MLM relying upon the data source(s) that may be faulty, such as GBM 220. In one example, the retraining may be triggered when an additional criterion is met, specifically, when the prediction accuracy of GBM 220 is also currently below a threshold. In one example, the triggering of the retraining may comprise disabling one or more of input factors 210 associated with the affected data source(s) (e.g., illustrated by labels 268 in FIG. 2). Thus, to the extent the disabled input factor(s) may have been relied upon for the predictive outcomes (e.g., fraud scores), the learning algorithm may adapt to rely upon other input factors to a greater degree. In other words, each training and/or testing example may omit the respective input factor associated with that data source. Similarly, data source verification module 260 may disable the feeds of one or more data sources to the input factors 210 (e.g., illustrated by labels 269 in FIG. 2). Thus, to the extent that a data source comprising an input factor 210 may be an enhanced/processed data source derived from data of one or more of telecommunication network service provider data source(s) 280 and/or third party data source(s) 290, the enhanced/processed data source may also be prevented from relying upon faulty source data.

In another example, data source verification module 260 may determine one or more alternative data sources, or input factors that may be available to replace one or more that are determined to have forecast upper or lower bounds exceeded for one or more characteristics. For example, there may be standby data sources that contain the same or similar data as the disabled data source, such as partially overlapping data, data from a same call but collected from a different type of network element, data from a same transaction but obtained from a different source (e.g., using server-side records instead of records collected from user endpoints regarding the same transaction(s)), and so on. Accordingly, in such an example, data source verification module 260 may populate the training data 230 with a different set of input factors (e.g., to comprise an input factor associated with the replacement data source), may instruct GBM 220 to utilize such a different input factor for training and in-service prediction, and so on. It is again noted that that architecture 200 is just one example logical arrangement that may be implemented via a processing system in accordance with the present disclosure. To illustrate, in another example, architecture 200 may further comprise one or more additional MLMs. Thus, when a data source is determined to have a characteristic that exceeds a forecast upper or lower bound, the remedial actions of disabling the associated input factor, MLM retraining, and so on, may be applied with respect to any or all of the MLMs that rely upon the input factor and/or the data source. In still another example, there may be alternative MLM for a same predictive task. In addition, one or more may comprise active MLMs, while others may be on standby (and not providing outputs to consuming application or users). In such an example, when a data source is determined to have a characteristic that exceeds a forecast upper or lower bound, an MLM relying upon the input factor and/or data source may be disabled, but may also be replaced by an alternative MLM for the same predictive task that may not reply upon the input factor and/or data source. Thus, these and other aspects are all contemplated within the scope of the present disclosure.

FIG. 3 illustrates an example flowchart of a method 300 for generating an alert in response to detecting that a first characteristic of data of a first data source associated with an input feature of a first machine learning model exceeds a forecast upper bound or a forecast lower bound of the first characteristic for a first time period. In one example, steps, functions, and/or operations of the method 300 may be performed by a device as illustrated in FIG. 1, e.g., one of servers 135. Alternatively, or in addition, the steps, functions and/or operations of the method 300 may be performed by a processing system collectively comprising a plurality of devices as illustrated in FIG. 1 such as one or more of server(s) 135, DB(s) 136, endpoint devices 111-113 and/or 121-123, devices 131-134, server(s) 155, and so forth. In one example, the steps, functions, or operations of method 300 may be performed by a computing device or processing system, such as computing system 400 and/or a hardware processor element 402 as described in connection with FIG. 4 below. For instance, the computing system 400 may represent at least a portion of a platform, a server, a system, and so forth, in accordance with the present disclosure. In one example, the steps, functions, or operations of method 300 may be performed by a processing system comprising a plurality of such computing devices as represented by the computing system 400. For illustrative purposes, the method 300 is described in greater detail below in connection with an example performed by a processing system. The method 300 begins in step 305 and proceeds to step 310.

At step 310, the processing system determines a plurality of input features of a first machine learning model, wherein the first machine learning model is deployed in a telecommunication network for a prediction task associated with an operation of the telecommunication network. In one example, the first machine learning model is for fraud detection. In another example, the first machine learning model may be for detecting network anomalies of the telecommunication network (e.g., radio access network (RAN) failures, link failures, denial of service (DoS) attacks, domain name service (DNS) hijacking, botnet activity, etc.).

At step 315, the processing system applies a time series forecast model to a historical data set of a first data source associated with at least one of the plurality of input features to generate a forecast upper bound of a first characteristic of the first data source for a first time period and a forecast lower bound of the first characteristic of the first data source for the first time period. For instance, the time series forecast model can be a S-Naïve model, a seasonal decomposition model, an autoregressive model, a moving average model, an exponential smoothing model, a dynamic linear model, a Facebook® Prophet model, an ARIMA model, a SARIMA model, a NNETAR model, a RNN model, or the like. In addition, in one example, different time series forecast models may be used for different characteristics, different data sources or types of data sources, etc. The first time period may comprise a day, for instance a next day or other upcoming day, a half-day, or other approaching time period that has yet to occur. In addition, the first characteristic of the first data source may comprise a data volume per time period of the first data source, data values of the data of the first data source, a percentage of null values of the data of the first data source, a number of clusters of the data of the first data source, a data type distribution of the data of the first data source, and so on.

In one example, the first data source may comprise an aggregate data source (e.g., an enhanced or processed data source) based upon data of at least two constituent data sources. In another example, the first data source is aggregated with at least one other data source to provide an aggregate data source associated with the at least one of the plurality of input features of the first machine learning model. In one example, the first data source comprises data obtained from at least one component of the telecommunication network. In another example, the first data source comprises data obtained from a computing system external to the telecommunication network (e.g., a third party data source). In one example, the first data source comprises data associated with users of the telecommunication network, e.g., users of wireless services and/or broadband services, users having home and business accounts, etc.

It should also be noted that although the terms, “first,” “second,” “third,” etc., are used herein, the use of these terms are intended as labels only. Thus, the use of a term such as “third” in one example does not necessarily imply that the example must in every case include a “first” and/or a “second” of a similar item. In other words, the use of the terms “first,” “second,” “third,” and “fourth,” does not necessarily imply a particular number of those items corresponding to those numerical values. In addition, the use of the term “third” for example, does not imply a specific sequence or temporal relationship with respect to a “first” and/or a “second” of a particular type of item, unless otherwise indicated.

At step 320, the processing system detects that the first characteristic of the first data source exceeds one of the forecast upper bound or the forecast lower bound during the first time period. For instance, the processing system may monitor the first data source during the first time period to compare current characteristics to the forecast upper and lower bounds.

At step 325, the processing system generates an alert that an output of the first machine learning model may be faulty, in response to the detecting. For instance, the alert may be appended to or included with output(s) of the first MLM, may be transmitted to devices of one or more network personnel responsible for operation of an MLM platform, may be transmitted to consumers, e.g., users or other computing system subscribers to the output of the first MLM, and so on.

At optional step 330, the processing system may monitor a prediction accuracy of the first machine learning model, in response to the detecting. For instance, the processing system may obtain a last available calculation of the prediction accuracy, or may monitor the prediction accuracy over a defined time period following the alert, e.g., for the next 6 hours, the next 12 hours, etc. (e.g., to the extent that truth labels may be obtained to determine the accuracy).

At optional step 335, the processing system may retrain the first machine learning model to exclude the first data source associated with the one of the plurality of input features and to provide a retrained first machine learning model, in response to the detecting. For instance, optional step 335 may comprise eliminating the input feature and/or replacing the input feature with a different data source that provides the same or similar information. In one example, the retraining may be based upon a first portion of historical data comprising a plurality of training examples for the first machine learning model. In one example, the retraining of optional step 335 is in response to determining, via the monitoring of optional step 330, that the prediction accuracy is below a threshold.

Alternatively, or in addition, in one example, the retraining of optional step 335 may be performed in response to a verification that the first data source is faulty. For instance, the verification can come from a provider of the first data source, personnel of the telecommunication network investigating and labeling the first data source as faulty, or via one or more automated tools (e.g., additional algorithms, such as other MLMs, for detecting that data is faulty). On the other hand, if the first data source is verified to not be faulty, it may be that fraudsters have recently learned how to manipulate the first data source or to avoid triggering or falling within the first data source, or a range of values of the first data source. In such case, it may be worthwhile to operate the first MLM “as-is” to detect fraudsters who may not have learned the latest evasion technique, while allowing a retrained version of the MLM (trained on examples that exclude the first data source), or a different MLM to operate in parallel for the same prediction task. Fraud warnings may then be triggered by either MLM (or both), or similarly with regard to a different prediction task.

At optional step 340, the processing system may apply the retrained first machine learning model to a second portion of historical data comprising a plurality of testing examples to generate a prediction accuracy of the retrained first machine learning model.

At optional step 345, the processing system may deploy the retrained first machine learning model to the telecommunication network when the prediction accuracy exceeds a threshold. For instance, the processing system may be configured to apply the retrained machine learning model only when the accuracy (determined at optional step 340) is sufficiently high (e.g., exceeds the threshold). Conversely, in one example, the (non-retrained) first machine learning model may continue to be operated when the prediction accuracy of the retrained first machine learning model does not exceed the threshold, e.g., with the alert of step 325 still being provided with the output(s) of the first machine learning mode to warn of the possibility that the output of the first machine learning model may be false or of a lesser confidence.

At optional step 350, the processing system may select a secondary data source to replace the first data source for the one of the plurality of input features. For instance, the secondary data source may have the same or similar data (such as partially overlapping data, complementary data (e.g., server-side data from the same transactions, calls, etc. also represented by user endpoint-side data from the first data source), etc.). In one example, optional step 350 may be performed if such a secondary data source is available, and if not already in use as a different data source for a different input feature of the first machine learning model. Thus, to the extent that the secondary data source does not exceed its own forecast upper or lower bounds for one or more characteristics, the output of the first machine learning model may be returned to the former reliability.

At optional step 355, the processing system may deploy, e.g., in response to the alert of step 325, a second machine learning model to the telecommunication network for the prediction task. For instance, the second machine learning model may be inactive, but ready for use, wherein the second machine learning model is also for the same prediction task, but does not rely upon the first data source for any of its input features. Thus, in one example, any issues with the first machine learning model resulting from the problems with the first data source may be made transparent to end consumer users or computing systems.

Following step 325 or any of optional steps 330-355, the method 300 ends in step 395.

It should be noted that method 300 may be expanded to include additional steps, or may be modified to replace steps with different steps, to combine steps, to omit steps, to perform steps in a different order, and so forth. For instance, in one example, the processing system may repeat one or more steps of the method 300, such as steps 310-355 for additional transactions or other examples. In one example, one or more steps of the method 300 may be repeated for different characteristics of the first data source, or other data sources associated with input factors of the first machine learning model. Similarly, in another example, the method 300 may include determining that first data source is associated with one of a plurality of input features of a second machine learning model (e.g., at least a second MLM) at step 310. For instance, the second MLM may be deployed in the telecommunication network for a second prediction task associated with the operation of the telecommunication network. In such case, the method 300 may include repeating one or more of steps 325-355 with regard to the second MLM, e.g., retraining the second MLM to exclude the first data source associated with the one of the plurality of input features of the second MLM and to provide a retrained second MLM, in response to the detecting, deploying the retrained second MLM to the telecommunication network, etc.

In one example, the method 300 may include training the first MLM (and/or other MLMs) in accordance with a training data set (e.g., groups/sets of input factors for completed transactions or other types of examples (e.g., users or endpoint device to be evaluated), and for which labels have been applied). In one example, the method 300 may include adjusting data filtering operations so as to correctly process telecommunication network service provider-sourced and/or third party-sourced data into input factors that are ready to be applied to the first machine learning model, and so on. For instance, it may be that the first data source is only out of bounds to the extent that the data format was changed (such as a data sampling rate being increased and thus the data representing double the volume or accumulate value as would have been provided before the change). In one example, the method 300 may further include obtaining the verification of the first data source being faulty (or conversely not being faulty). In one example, the method 300 may further include providing a notification of the verification and/or the fault of the first data source to a third party provider of the first data source (if not the originator of the verification). In yet another example, alerting and/or retraining may be when at least two characteristics of the data of the first data source exceed respective forecast upper or lower bounds (e.g., bounds are exceed for at least two characteristics). Thus, these and other modifications are all contemplated within the scope of the present disclosure.

In addition, although not specifically specified, one or more steps, functions, or operations of the method 300 may include a storing, displaying, and/or outputting step as required for a particular application. In other words, any data, records, fields, and/or intermediate results discussed in the method 300 can be stored, displayed and/or outputted either on the device(s) executing the method 300, or to another device or devices, as required for a particular application. Furthermore, steps, blocks, functions, or operations in FIG. 3 that recite a determining operation or involve a decision do not necessarily require that both branches of the determining operation be practiced. In other words, one of the branches of the determining operation can be deemed as an optional step. In addition, one or more steps, blocks, functions, or operations of the above described method 300 may comprise optional steps, or can be combined, separated, and/or performed in a different order from that described above, without departing from the examples of the present disclosure.

It should be noted that any uses of the plurality of data sources in accordance with the embodiments of the present disclosures are performed with the consent and/or authority of the owners or operators of the plurality of data sources. In some instances, the particular individual, subscriber, or consumer may provide such consent and/or authorization, e.g., allowing a retail associate to perform a credit check, an account verification check, a financial reference check, an employment verification check, and so on. Alternatively or in addition to such consent and/or authority, the uses of the plurality of data sources may include anonymizing any identifying features that can be traced back to a particular individual, subscriber, or consumer.

FIG. 4 depicts a high-level block diagram of a computing system 400 (e.g., a computing device, or processing system) specifically programmed to perform the functions described herein. For example, any one or more components or devices illustrated in FIG. 1, or described in connection with the process 200 of FIG. 2 or the method 300 of FIG. 3 may be implemented as the computing system 400. As depicted in FIG. 4, the computing system 400 comprises a hardware processor element 402 (e.g., comprising one or more hardware processors, which may include one or more microprocessor(s), one or more central processing units (CPUs), and/or the like, where hardware processor element may also represent one example of a “processing system” as referred to herein), a memory 404, (e.g., random access memory (RAM), read only memory (ROM), a disk drive, an optical drive, a magnetic drive, and/or a Universal Serial Bus (USB) drive), a module 405 for generating an alert in response to detecting that a first characteristic of data of a first data source associated with an input feature of a first machine learning model exceeds a forecast upper bound or a forecast lower bound of the first characteristic for a first time period, and various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 402 is shown, it should be noted that the computing device may employ a plurality of hardware processor elements. Furthermore, although only one computing device is shown in FIG. 4, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of FIG. 4 is intended to represent each of those multiple computing devices. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor element 402 can also be configured or programmed to cause other devices to perform one or more operations as discussed above. In other words, the hardware processor element 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for generating an alert in response to detecting that a first characteristic of data of a first data source associated with an input feature of a first machine learning model exceeds a forecast upper bound or a forecast lower bound of the first characteristic for a first time period (e.g., a software program comprising computer-executable instructions) can be loaded into memory 404 and executed by hardware processor element 402 to implement the steps, functions or operations as discussed above in connection with the example method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for generating an alert in response to detecting that a first characteristic of data of a first data source associated with an input feature of a first machine learning model exceeds a forecast upper bound or a forecast lower bound of the first characteristic for a first time period (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
determining, by a processing system including at least one processor, a plurality of input features of a first machine learning model, wherein the first machine learning model is deployed in a telecommunication network for a prediction task associated with an operation of the telecommunication network;
applying, by the processing system, a time series forecast model to a historical data set of a first data source associated with at least one of the plurality of input features to generate a forecast upper bound of a first characteristic of the first data source for a first time period and a forecast lower bound of the first characteristic of the first data source for the first time period;
detecting, by the processing system, that the first characteristic of the first data source exceeds one of: the forecast upper bound or the forecast lower bound during the first time period; and
generating, by the processing system, an alert that an output of the first machine learning model may be faulty, in response to the detecting.

2. The method of claim 1, further comprising:
retraining the first machine learning model to exclude the first data source associated with the one of the plurality of input features and to provide a retrained first machine learning model, in response to the detecting.

3. The method of claim 2, wherein the retraining is based upon a first portion of historical data comprising a plurality of training examples for the first machine learning model.

4. The method of claim 3, further comprising:
applying the retrained first machine learning model to a second portion of historical data comprising a plurality of testing examples to generate a prediction accuracy of the retrained first machine learning model.

5. The method of claim 4, further comprising:
deploying the retrained first machine learning model to the telecommunication network when the prediction accuracy exceeds a threshold.

6. The method of claim 2, further comprising:
monitoring a prediction accuracy of the first machine learning model, in response to the detecting, wherein the retraining is in response to determining, via the monitoring, that the prediction accuracy is below a threshold.

7. The method of claim 2, wherein the retraining comprises:
selecting a secondary data source to replace the first data source for the one of the plurality of input features.

8. The method of claim 2, wherein the retraining is in response to a verification that the first data source is faulty.

9. The method of claim 2, further comprising:
determining that the first data source is associated with one of a plurality of input features of a second machine learning model, wherein the second machine learning model is deployed in the telecommunication network for a second prediction task associated with the operation of the telecommunication network; and
retraining the second machine learning model to exclude the first data source associated with the one of the plurality of input features of the second machine learning model and to provide a retrained second machine learning model, in response to the detecting.

10. The method of claim 9, further comprising:
deploying the retrained second machine learning model to the telecommunication network.

11. The method of claim 1, further comprising:
deploying, in response to the alert, a second machine learning model to the telecommunication network for the prediction task.

12. The method of claim 1, wherein the first time period comprises a day.

13. The method of claim 1, wherein the first characteristic of the first data source comprises:
a data volume per time period of the first data source;
data values of the data of the first data source;
a percentage of null values of the data of the first data source;
a number of clusters of the data of the first data source; or
a data type distribution of the data of the first data source.

14. The method of claim 1, wherein the first data source is an aggregate data source based upon data of at least two constituent data sources.

15. The method of claim 1, wherein the first data source is aggregated with at least one other data source to provide an aggregate data source associated with the at least one of the plurality of input features of the first machine learning model.

16. The method of claim 1, wherein the first data source comprises data obtained from at least one component of the telecommunication network.

17. The method of claim 1, wherein the first data source comprises data obtained from a computing system external to the telecommunication network.

18. The method of claim 1, wherein the first data source comprises data associated with users of the telecommunication network.

19. A non-transitory computer-readable medium storing instructions which, when executed by a processing system including at least one processor, cause the processing system to perform operations, the operations comprising:
determining a plurality of input features of a first machine learning model, wherein the first machine learning model is deployed in a telecommunication network for a prediction task associated with an operation of the telecommunication network;
applying a time series forecast model to a historical data set of a first data source associated with at least one of the plurality of input features to generate a forecast upper bound of a first characteristic of the first data source for a first time period and a forecast lower bound of the first characteristic of the first data source for the first time period;
detecting that the first characteristic of the first data source exceeds one of the forecast upper bound or the forecast lower bound during the first time period; and
generating an alert that an output of the first machine learning model may be faulty, in response to the detecting.

20. An apparatus comprising:
a processing system including at least one processor; and
a non-transitory computer-readable medium storing instructions which, when executed by the processing system, cause the processing system to perform operations, the operations comprising:
determining a plurality of input features of a first machine learning model, wherein the first machine learning model is deployed in a telecommunication network for a prediction task associated with an operation of the telecommunication network;
applying a time series forecast model to a historical data set of a first data source associated with at least one of the plurality of input features to generate a forecast upper bound of a first characteristic of the first data source for a first time period and a forecast lower bound of the first characteristic of the first data source for the first time period;
detecting that the first characteristic of the first data source exceeds one of the forecast upper bound or the forecast lower bound during the first time period; and
generating an alert that an output of the first machine learning model may be faulty, in response to the detecting.
